(19) United States
(12) Patent Application Publication
(10) Pub. No.: US 2021/0186203 A1
(43) Pub. Date: Jun. 24, 2021

(54) GRILL CLEANER

(71) Applicant: Kiel Webb, Waterloo (CA)

(72) Inventor: Kiel Webb, Waterloo (CA)

(21) Appl. No.: 17/127,003

(22) Filed: Dec. 18, 2020

Related U.S. Application Data
(60) Provisional application No. 62/950,242, filed on Dec. 19, 2019.

(51) Int. Cl. A46D 1/00; A47J 37/07; A46B 5/02; A46B 7/04; A46B 3/04; A46B 9/02

(52) U.S. Cl. CPC A46D 1/0253; A47J 37/0786; A46B 5/02; A46B 7/042; A46B 2200/3093; A46B 9/026; A46D 1/0246; A46D 1/0207; A46B 2200/3033; A46B 3/04

(57) ABSTRACT

A grill cleaner, comprising a head having a plurality of coil springs, each coil spring having a proximate end embedded in the head and a distal application end projecting from the head, the distal application ends shaped for coordinated application to a surface. A grill cleaner, comprising a cleaner head; a spring mount secured to the cleaner head by a press fit, the spring mount holding a plurality of coil springs, each spring of the plurality of coil springs having a proximate end secured to the spring mount and a distal application end projecting from the head, the distal applications ends shaped for coordinated application to a surface.

### CROSS-REFERENCE TO RELATED PATENT APPLICATION

The application claims the benefit of U.S. Provisional Application No. 62/950,242, filed on Dec. 19, 2019. The complete disclosure of U.S. Provisional Application No. 62/950,242 is incorporated herein by reference.

### TECHNICAL FIELD

The disclosure relates to a grill cleaner, particularly a grill cleaner incorporating springs.

### BACKGROUND

U.S. Pat. No. 5,881,426 purports to disclose a brush with flexible bristles in which each bristle includes a flexion integral with the bristle to provide innate resilience to the bristle for flexing along its longitudinal axis. The brush fitted with the bristles includes a perforated brushhead for passing the bristles so as to maintain the bristles on their axis. A trapezoidal bristle grid provides for bristle density in the brush comparable the standard brush density.

U.S. Pat. No. 8,683,641 purports to disclose a novel scraper assembly having a plurality of interchangeable scraper heads and handles and corresponding method for use. The scraper assembly further comprises a plurality of abrasive mechanisms, namely spring bristles, coiled springs, chainmail abraders and wire cloth abraders capable of effectively cleaning a surface without scoring or otherwise damaging the surface. The invention may be particularly useful for cleaning grills and ovens. Additionally, the invention may also be useful for shaping, adding texture to, stripping materials from or otherwise preparing a surface, including wood, metal or ceramic surfaces.

United States Patent Application Publication No. 2017/0326599 purports to disclose a scraper for a barbeque grill comprises a handle. A substantially parallelepiped cleaning head is extended at a forward end of the handle. The cleaning head comprises a first metal plate and a second metal plate. A plurality of metal spikes is mounted to and extends from at least one surface of the cleaning head. The plurality of metal spikes move centrifugal swivel movement at an angle of 15 degrees for inserting into open spaces of the barbecue grill. The plurality of metal spikes provides side-to-side swinging motion to remove the charred debris from the top and side portions of the barbecue grill.

### SUMMARY

In a first aspect, some embodiments of the invention provide a grill cleaner, comprising a head having a plurality of coil springs, each coil spring having a proximate end embedded in the head and a distal application end projecting from the head, the distal application ends shaped for coordinated application to a surface.

In some embodiments, the grill cleaner further comprises a handle coupled to and extending from the head, the handle oriented for use in driving the head in a grill cleaning operation

In some embodiments, the head includes a main body member and a removable member, the removable member removably securable to the main body member, the plurality of coil springs embedded in the removable member.

In some embodiments, the removable member is a socket insert and the main body member has a socket cavity shaped to receive the socket insert and to hold the socket insert when the socket insert is secured to the main body member.

In some embodiments, each coil spring is an extension spring.

In some embodiments, the socket insert is removably coupled in the socket insert via a spring lock.

In some embodiments, the handle is an elongated handle.

In some embodiments, the handle has a handle axis and the head defines an operational plane, the handle axis forming an oblique angle with the operational plane.

In some embodiments, the springs are overmolded by the head.

In some embodiments, the head has a grill facing surface and the grill facing surface is convexly curved.

In some embodiments, each coil spring of the plurality of coil springs has an axis of extension, the plurality of axis of extension being mutually parallel.

In a first aspect, some embodiments of the invention provide a grill cleaner, comprising a cleaner head; a spring mount secured to the cleaner head by a press fit, the spring mount holding a plurality of coil springs, each spring of the plurality of coil springs having a proximate end secured to the spring mount and a distal application end projecting from the head, the distal applications ends shaped for coordinated application to a surface.

In some embodiments, the grill cleaner further comprises a handle coupled to and extending from the head, the handle oriented for use in driving the head in a grill cleaning operation.

In some embodiments, the spring mount includes a retaining plate having a head face and an opposite grill face and a plurality of apertures therethrough from the head face to the grill face, each spring of the plurality of springs passing through one of the plurality of apertures with the proximate end retained adjacent the head face and the distal end extending from the grill face.

In some embodiments, each spring of the plurality of springs has a proximate end diameter and a main body diameter, the proximate end diameter larger than the main body diameter.

In some embodiments, the spring mount includes a back plate secured to the retaining plate, the proximate ends of the plurality of springs held between the back plate and the retaining plate.

In some embodiments, the back plate includes a plurality of bosses, the plurality of bosses including one boss for each coil spring of the plurality of coil springs and each of the plurality of bosses positioned on the back plate to be inserted into a coil spring when the proximate ends of the plurality of springs are held between the back plate and the retaining plate.

In some embodiments, each coil spring of the plurality of coil springs has an axis of extension, the plurality of axis of extension being mutually parallel.

In some embodiments, the spring mount includes at least two press-fit legs each press fit into the head, the at least two press-fit legs supporting a retaining plate, each spring of the plurality of coil springs having a proximate end secured to the retaining plate.

In some embodiments, the legs are each oriented generally vertically and the retaining plate is oriented generally horizontally.

### BRIEF DESCRIPTION OF THE DRAWINGS

The drawings included herewith are for illustrating various examples of systems, methods, and apparatus of the present specification. In the drawings:

FIG. 1 is a bottom perspective view of a grill cleaner, according to an embodiment;

FIG. 2 is an expanded bottom perspective view of a portion of the grill cleaner of FIG. 1;

FIG. 3 is a top plan view of the grill cleaner of FIG. 1;

FIG. 4 is a cross sectional view of the grill cleaner of FIG. 1, taken along the line 4-4 of FIG. 3;

FIG. 5 is a top perspective view of a spring mount, according to an embodiment;

FIG. 6 is a right side elevation view of the spring mount of FIG. 5;

FIG. 7 is an exploded top perspective view of the spring mount of FIG. 5;

FIG. 8 is a partially exploded top perspective view of the spring mount of FIG. 5, with the back plate removed;

FIG. 9 is an expanded top perspective view of a portion of the spring mount of FIG. 5;

FIG. 10 is a top plan view of the spring mount of FIG. 5, with the back plate removed;

FIG. 11 is a front end view of the spring mount of FIG. 5;

FIG. 12 is an exploded top perspective view of a spring mount, according to an embodiment;

FIG. 13 is a top perspective view of the spring mount of FIG. 12;

FIG. 14 is a front end elevation view of the spring mount of FIG. 12; and

FIG. 15 is a right side elevation exploded view of the spring mount of FIG. 12.

### DETAILED DESCRIPTION

Various apparatus or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

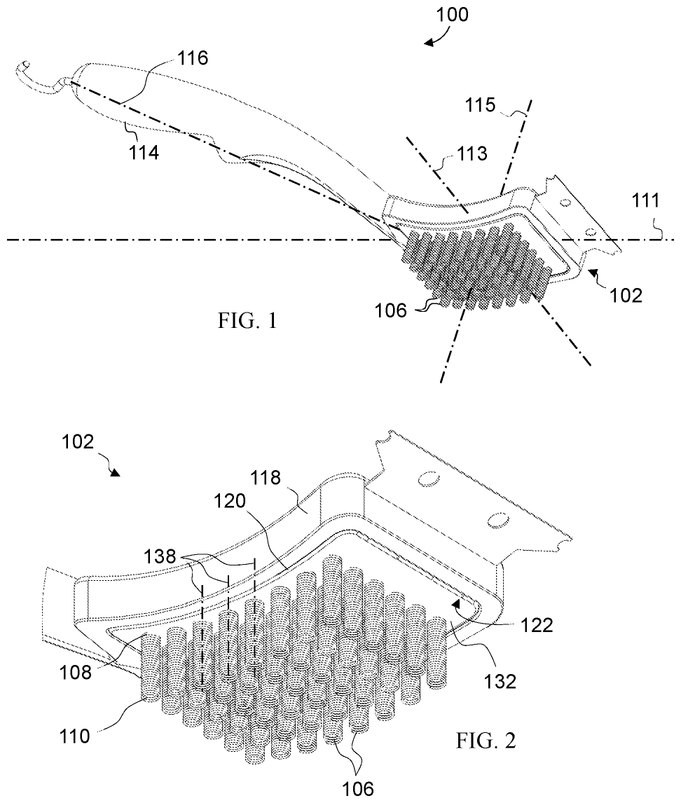

Referring to FIG. 1, an exemplary grill cleaner 100 includes a head 102 and a plurality of coil springs 106. In the illustrated example, each coil spring 106 is an extension or tension spring. Each coil spring 106 has a proximate end 108 embedded in the head 102 and a distal application end 110 projecting from the head 102 and provided for application to a grill surface in a grill cleaning operation. Although in other embodiments, grill cleaner 100 may be used to clean other surfaces.

In the illustrated example each spring 106 is a metal spring embedded in a plastic head 102 by being overmolded by the head 102. However, in other embodiments one or more of springs 106 and head 102 may be made of alternate materials, such as materials that are strong enough for a grill cleaning operation. For example, head 102 may be made of, or incorporate, metal.

Grill cleaner 100 includes a handle 114 secured to head 102. In the illustrated example, handle 114 is an elongated handle coupled to and extending from the head 102. For example, handle 114 may be welded to head 102 or secured by fasteners. The handle 114 is oriented for use in driving the head in a grill cleaning operation. Handle 114 is illustrated as a solid molded plastic handle, although in some embodiments handle 114 may be made of a bent metal shaft. For example, handle 114 may be formed of a brushed aluminum shaft having a proximate end press-fit into head 102 and a distal end having a plastic hand grip formed thereon.

In the illustrated example, grill cleaner 100 has a longitudinal axis 111, a transverse axis 113, and a vertical axis 115. The longitudinal axis 111 and the transverse axis 113 define an operational plane of the head 102. In the illustrated example, handle 114 has a handle axis of extension 116 rising vertically from the operational plane and forming an oblique angle with the operational plane.

Referring to FIG. 2, the head 102 of exemplary grill cleaner 100 includes a main body member 118 and a removable member 120. The removable member 120 is removably securable to the main body member 118, and the plurality of coil springs 106 are embedded in the removable member 120.

In the illustrated embodiment, the removable member 120 is a socket insert and the main body member 118 has a socket cavity 122 shaped to receive the socket insert 120. The main body member 118 is shaped to hold the socket insert 120 when the socket insert 120 is secured to the main body member 118.

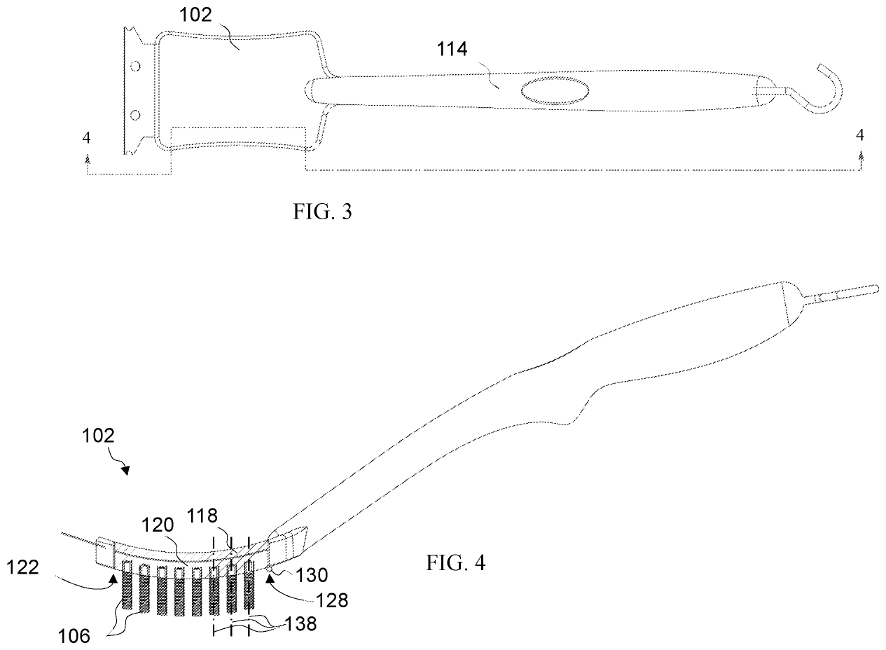

Referring to FIGS. 3 and 4, in the illustrated example the main body 118 and the socket insert 120 include a spring lock structure 128. Spring lock structure 128 includes a pair of rigid forward projections (not shown) on socket insert 120, each corresponding to a forward recess (not shown) in the wall of socket cavity 122. Spring lock structure 128 also includes a moveable rear clip 130 on socket insert 120, the moveable rear clip 130 corresponding to a rear recess (not shown) in the wall of socket cavity 122. Rear clip 130 is moveable between a retracted position and an extended position. In the retracted position, the rear clip is freed from the rear recess so that the socket insert 120 may be removed from socket cavity 122. In the extended position, the rear clip 130 is received in the rear recess to cooperate with the forward projections received in the forward recesses to hold the socket insert 120 in the socket cavity 122. The rear clip 130 is biased by a spring toward the extended position and may be moved to a retracted position to allow the socket insert 120 to be removed from the socket cavity 122.

Referring again to FIG. 2, in the illustrated example, the plurality of springs 106 are arranged in a rectangular array of eight rows and six columns. However, in other embodiments the plurality of springs may be arranged in alternate arrays, including arrays in which the springs are not arranged in rows and/or columns.

Distal ends 110 are shaped for coordinated application to a surface. In the illustrated example, each spring has generally the same length extending from the grill facing surface and is overmolded by the socket insert 120. The grill facing surface 132 of socket insert 120 of head 102 is a convexly curved surface bowed downward along the longitudinal axis. The distal application ends 110 of springs 106 correspondingly lie in a convexly curved plane (see for example FIG. 4). However, in other embodiments the grill facing surface 132 may have an alternative surface, such as being concave, flat, or undulating. Alternatively, or additionally, in some embodiments the springs may have unequal lengths extending from the grill face, such as if the springs 106 are of unequal total lengths and/or the springs 106 are of equal total lengths but have unequally sized portions embedded in head 102. In some embodiments, having springs of unequal lengths extending from the head 102 may allow for coordinated application to a surface, such as if the surface is ridged or otherwise non-planar.

In the illustrated example, each coil spring of the plurality of coil springs has an axis of extension 138, and the plurality of axis of extension are mutually parallel. However, in other embodiments, the axis of extension 138 may not be mutually parallel. For example, coordinated application of distal ends 110 to a non-planar surface may be made easier if the axis of extension 138 are not mutually parallel.

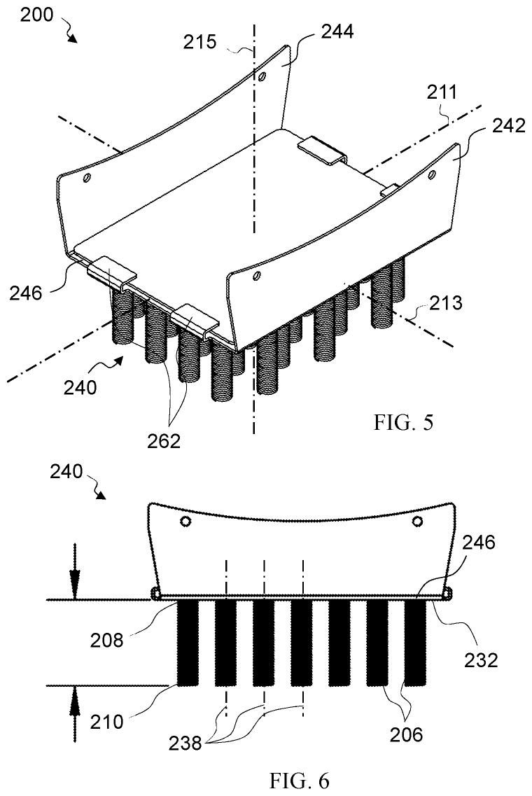

Referring to FIG. 5, another example of a grill cleaner 200 is illustrated. The grill cleaner 200 is similar in many respects to grill cleaner 100, and like features are identified by like reference characters, incremented by 100.

Grill cleaner 200 includes a cleaner head (not shown) and a spring mount 240. Spring mount 240 is secured to the cleaner head by a press fit. In the illustrated example, spring mount 240 includes a two press-fit legs 242, 244, each leg 242, 244 provided to be press fit into the head. However, in other embodiments other press-fit members may be used.

As illustrated, the two press-fit legs 242, 244 support a retaining plate 246 for retaining proximate ends of the plurality of springs. However, in other embodiments the springs may be secured to the spring mount in other ways, such as by being embedded in a metal or plastic spring mount body.

In the illustrated example, grill cleaner 200 has a longitudinal axis 211, a transverse axis 213, and a vertical axis 215. The longitudinal axis 211 and the transverse axis 213 define an operational plane of the head. In the illustrated example, each leg 242, 244 is oriented generally vertically, relative the operational plane, and is generally planar in shape. The retaining plate 246 is oriented generally horizontally and is also generally planar in shape. While illustrated oriented generally vertically or horizontally, in other embodiments one or more of press-fit members or retaining members may be otherwise angled, including being curved.

In the illustrated example the retaining plate 246 and the press-fit legs 242, 244 are integrally formed of a single plate. Although, in other embodiments, they may be joined together, such as by welding if the components are made of or incorporate metal or plastic.

Referring to FIG. 6, spring mount 240 holds a plurality of coil springs 206. Coil springs 206 may be metal. Each spring 206 includes a proximate end 208 secured to the spring mount 240 and a distal application end 210 projecting from the head and provided for application to a grill surface in a grill cleaning operation.

In the illustrated example, the grill cleaner 210 includes a handle (not shown) coupled to and extending from the head. The handle is oriented for use in driving the head in a grill cleaning operation.

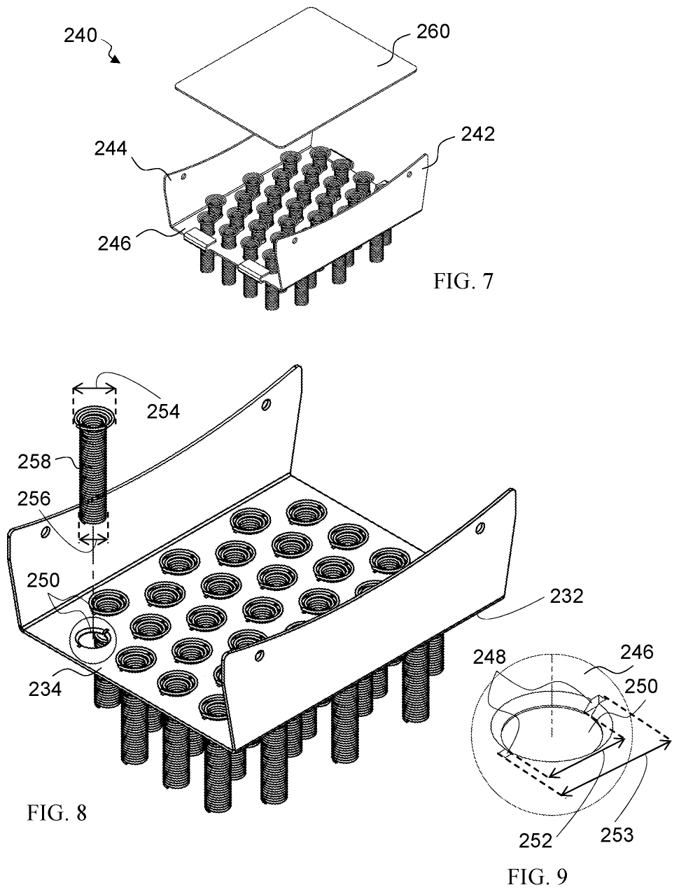

Referring to FIGS. 7 to 9, in the illustrated example, the retaining plate 246 has a grill face 232 and a opposite head face 234 and a plurality of apertures 250 therethrough from the head face 234 to the grill face 232. Each spring 106 is passed through one aperture 250 with the proximate end 208 retained by retaining plate 246 adjacent the head face 234 and the distal end 210 extending from the grill face 232. In the illustrated example, each spring 206 is retained because the proximate end 208 has a proximate end diameter 254 which is greater than the main body diameter 256. However, in other embodiments each spring 206 may be otherwise retained, such as by a clip or other fastener.

In the illustrated example, the spring mount 240 includes a back plate 260 secured to the retaining plate 246. When spring mount 240 is assembled, the proximate ends 208 of the springs 206 are held between the back plate and the retaining plate 246.

Each aperture 250 includes notches 248. Notches 248 serve to extend an aperture diameter 252 to an extended aperture diameter 253. In the illustrated example, the main body diameter 256 of the main body portion 258 and distal application end 210 of each spring 206 is larger in size than the aperture diameter 252 but smaller than the extended aperture diameter 253. Notches 248 are provided to receive a wire of a coil of spring 206 so that spring 206 can fit through aperture 250. Noteches 248 allow aperture 250 to more firmly hold spring 206 as spring 206 is captured by aperture 250. However, the proximate end diameter 254 is larger than the extended aperture diameter 253, preventing the proximate end 208 from passing through the aperture 250.

In other embodiments, however, notches 248 may not be provided. For example, in some embodiments spring main body diameter 256 may be smaller than aperture diameter 252 so that spring 206 may be passed through aperture 250. In some embodiments spring 206 may

Back plate 260 is held adjacent retaining plate 246. In the illustrated example, back plate 260 is held adjacent retaining plate 256 by fasteners 262. In the illustrated embodiment, fasteners 262 are clips anchored to retaining plate 246 and releasably securable to back plate 260. However, in other embodiments the back plate 260 may be held by other fasteners, such as threaded fasteners, adhesives, or magnets, and fasteners 262 may be releasably secured, directly or indirectly, to either or both of the back plate 260 and the retaining plate 246.

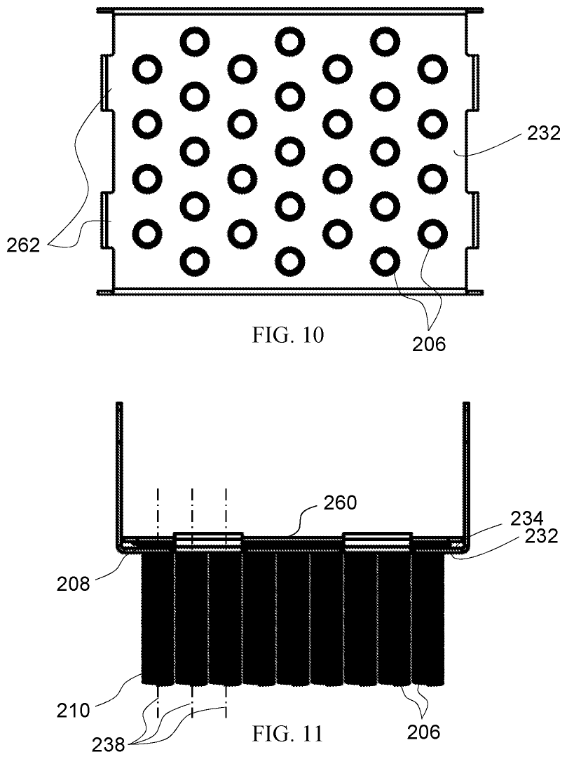

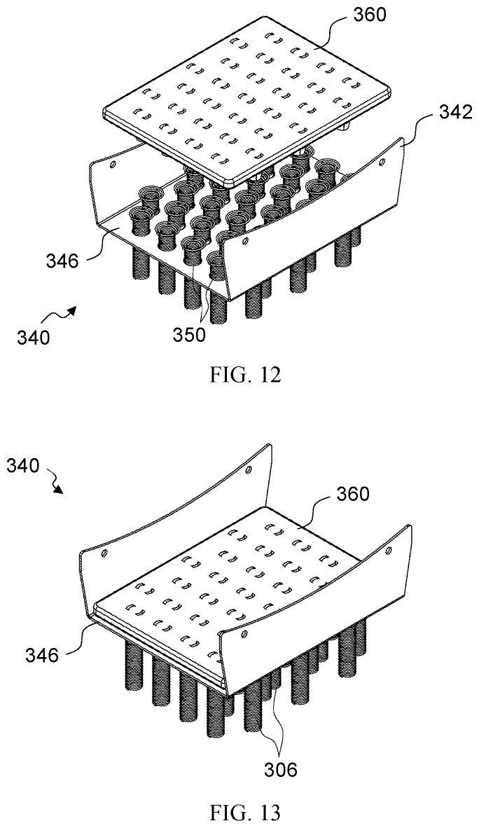

Referring to FIGS. 10 and 11, springs 206 are positioned in nine rows extending longitudinally and seven rows extending transversely. Alternate rows are staggered. Springs 206 are arranged with a small clearance between adjacent longitudinal rows and a larger clearance between adjacent transverse rows. In the illustrated example, each coil spring 206 has an axis of extension 238, and the plurality of axis of extension 238 are mutually parallel. However, other arrangements of springs may be used in other embodiments for coordinated application of distal ends 210 to a surface.

Referring to FIGS. 12 to 14, another example of a spring mount 340 is illustrated. The spring mount 340 is similar in many respects to spring mount 240, and like features are identified by like reference characters, incremented by 100.

Spring mount 340 includes a retaining plate 346 and a back plate 360. Back plate 360 includes a plurality of bosses 364. The plurality of bosses 364 includes one boss for each coil spring 306. Each boss 364 is positioned on the back plate 360 to be inserted into a coil spring 306 when the proximate end 308 of the coil spring 306 is held between the back plate 360 and the retaining plate 346. The plurality of bosses 364 each extend from a grill facing surface 366 of back plate 360, and the plurality of bosses and the plurality of apertures 350 have a common pattern so that the bosses align with coil springs 306 received in apertures 350.

In the illustrated embodiment, bosses 364 are cylindrical in shape. A proximate end 368 of each boss 364 is secured to back plate 360 while a distal end 370 extends from back plate 360 to be inserted into a spring 306 within the coil of the spring 306.

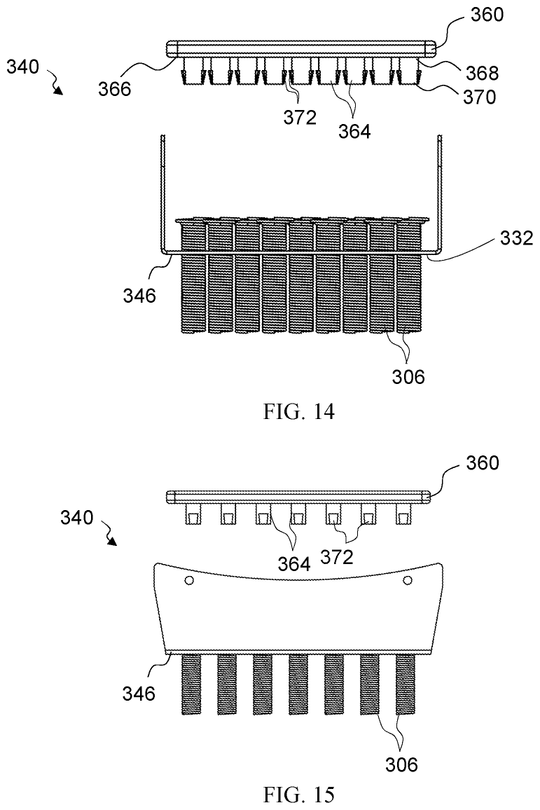

Referring to FIGS. 14 and 15, teeth 372 are formed on distal end 370. Teeth 372 allow back plate 360 to be held to retaining plate 346 as teeth 372 engage grill face 332 from within spring 306. In some embodiments, teeth 372 also assist in securely holding springs 306 in position and aligned vertically. In some embodiments, teeth 372 may act through spring 306 and indirectly engage grill face 332 by pushing one or more coils of spring 306 outward, while in other embodiments teeth 372 may project between coils of spring 306 or otherwise act past spring 306.

In the illustrated example, each boss 364 has two teeth 372 formed on distal end 370. However, in other embodiments a boss may have other teeth arrangements, such as a single tooth or a flange around the entire distal end 370.

In some embodiments, bosses 364 are solid plastic cylinders. In other embodiments, bosses 364 may be hollow, such as to ease manufacturing or use of the spring mount or to save material. In some embodiments, bosses 364 and/or back plate 360 may be made of metal rather than the plastic of the illustrated embodiment. For example, if retaining plate 346 is made of stainless steel, in some embodiments back plate 360 may also be made of stainless steel for aesthetic or durability reasons.

The present invention has been described here by way of example only. Various modification and variations may be made to these exemplary embodiments without departing from the scope of the invention, which is limited only by the appended claims.

1. A grill cleaner, comprising:
a head having a plurality of coil springs, each coil spring having a proximate end embedded in the head and a distal application end projecting from the head, the distal application ends shaped for coordinated application to a surface.

2. The grill cleaner of claim 1, further comprising a handle coupled to and extending from the head, the handle oriented for use in driving the head in a grill cleaning operation

3. The grill cleaner of claim 2, wherein the head includes a main body member and a removable member, the removable member removably securable to the main body member, the plurality of coil springs embedded in the removable member.

4. The grill cleaner of claim 3, wherein the removable member is a socket insert and the main body member has a socket cavity shaped to receive the socket insert and to hold the socket insert when the socket insert is secured to the main body member.

5. The grill cleaner of claim 4, wherein each coil spring is an extension spring.

6. The grill cleaner of claim 4, wherein the socket insert is removably coupled in the socket insert via a spring lock.

7. The grill cleaner of claim 2, wherein the handle is an elongated handle.

8. The grill cleaner of claim 3, wherein the handle has a handle axis and the head defines an operational plane, the handle axis forming an oblique angle with the operational plane.

9. The grill cleaner of claim 1, wherein the springs are overmolded by the head.

10. The grill cleaner of claim 1, wherein the head has a grill facing surface and the grill facing surface is convexly curved.

11. The grill cleaner of claim 10, wherein each coil spring of the plurality of coil springs has an axis of extension, the plurality of axis of extension being mutually parallel.

12. A grill cleaner, comprising:
a cleaner head;
a spring mount secured to the cleaner head by a press fit, the spring mount holding a plurality of coil springs, each spring of the plurality of coil springs having a proximate end secured to the spring mount and a distal application end projecting from the head, the distal applications ends shaped for coordinated application to a surface.

13. The grill cleaner of claim 12, further comprising a handle coupled to and extending from the head, the handle oriented for use in driving the head in a grill cleaning operation.

14. The grill cleaner of claim 12, wherein the spring mount includes a retaining plate having a head face and an opposite grill face and a plurality of apertures therethrough from the head face to the grill face, each spring of the plurality of springs passing through one of the plurality of apertures with the proximate end retained adjacent the head face and the distal end extending from the grill face.

15. The grill cleaner of claim 12, wherein each spring of the plurality of springs has a proximate end diameter and a main body diameter, the proximate end diameter larger than the main body diameter.

16. The grill cleaner of claim 12, wherein the spring mount includes a back plate secured to the retaining plate, the proximate ends of the plurality of springs held between the back plate and the retaining plate.

17. The grill cleaner of claim 16, wherein the back plate includes a plurality of bosses, the plurality of bosses including one boss for each coil spring of the plurality of coil springs and each of the plurality of bosses positioned on the back plate to be inserted into a coil spring when the proximate ends of the plurality of springs are held between the back plate and the retaining plate.

18. The grill cleaner of claim 12, wherein each coil spring of the plurality of coil springs has an axis of extension, the plurality of axis of extension being mutually parallel.

19. The grill cleaner of claim 12, wherein the spring mount includes at least two press-fit legs each press fit into the head, the at least two press-fit legs supporting a retaining plate, each spring of the plurality of coil springs having a proximate end secured to the retaining plate.

20. The grill cleaner of claim 19, wherein the legs are each oriented generally vertically and the retaining plate is oriented generally horizontally.
